(19) United States
(12) Patent Application Publication
(10) Pub. No.: US 2023/0378571 A1
(43) Pub. Date: Nov. 23, 2023

(54) RECHARGEABLE ELECTRIC ENERGY ACCUMULATOR WITH METAL-AIR ELECTROCHEMICAL CELL WITH CONTINUOUS FLOW OF OXIDANT AND ANTI-DEGRADATION DEVICES

(71) Applicant: Fausto Maria VENTRIGLIA, GROTTAFERRATA (IT)

(72) Inventor: Fausto Maria VENTRIGLIA, GROTTAFERRATA (IT)

(21) Appl. No.: 18/246,912

(22) PCT Filed: Dec. 27, 2021
(86) PCT No.: PCT/IT2021/050427

§ 371 Date: Mar. 28, 2023

(30) Foreign Application Priority Data
Dec. 30, 2020 (IT) 102020000032798

(51) Int. Cl. H01M 12/08; H01M 8/0662; H01M 4/38; H01M 8/02; H01M 10/42; H01M 8/04089; H01M 50/138; H01M 50/103; H01M 50/107

(52) U.S. Cl. CPC H01M 12/08; H01M 8/0662; H01M 4/38; H01M 8/02; H01M 10/4214; H01M 8/04089; H01M 50/1385; H01M 50/103; H01M 50/107; H01M 2004/027

(57) ABSTRACT

A rechargeable electrical energy accumulator including a metal-air electrochemical cell, or battery, and an oxygen and nitrogen separator/concentrator connected to the battery for separating and concentrating, separately, the oxygen and nitrogen present in the air The battery includes a container made of non-conductive material and a reaction chamber, the reaction chamber containing at least one metal anode, at least one cathode, connected to said oxygen and nitrogen separator/concentrator, and an electrolyte placed in contact with said at least one metal anode and at least one cathode. The metal-air battery includes capabilities for inertization of the anode by interposing an inert gas between said at least one anode (and said electrolyte when the battery is not in use, ultrasonic piezoelectric transducers, positioned near the edge of the container and/or on the surface of the least one anode, immersed in the electrolyte, the piezoelectric ultrasonic transducers generating a continuous ultrasonic pressure wave.

### FIELD

This invention relates to a rechargeable electric energy accumulator with metal-air electrochemical cell with continuous flow of oxidant and anti-degradation devices.

More in detail, the invention relates to an electric energy accumulator with a metal-air electrochemical cell comprising systems capable of overcoming the problems of degradation and passivation of the metal, the aggregation of the reaction by-product and which allows the oxidative capacities of the anode to be maximised.

### BACKGROUND

As is well known, metal-air batteries are based on a technology known since 1914 (Charles Féry) and have been tested and used since the early 90s.

They are based on the oxidation property and the electronegative potential of some metals and on the use of atmospheric air to supply the oxygen necessary for the reaction. Their rewarding feature is the high energy density, both in volume and weight, and the (relative) low cost. The most suitable metals for their manufacture are: Calcium (Ca), Aluminum (Al), Lithium (Li), Iron (Fe), Cadmium (Cd), Zinc (Zi). With the exception of Lithium, all the metals listed allow the use of water-based electrolytes. In all cases the cathode uses air (oxygen) for the reaction.

Metal-air batteries are open systems and belong to the category of “Primary Cells”, that is, batteries that cannot be directly recharged (such as a lead-acid battery) but can be “regenerated”, recovering the by-product of the reaction, consisting of a metal oxide, with which to regenerate the operational metal.

The widespread technique for this type of battery consists of a metal anode surrounded by a suitable electrolyte in contact with a conducting cathode in turn in contact with a membrane permeable to oxygen which is exposed to the atmospheric air. The reaction of oxygen with the electrolyte induces an ionization and a subsequent oxidation of the anode with the production of free electrons and a metal oxide as a reaction by-product. The construction scheme of these batteries is simple and quite robust.

Given the high energy density and ease of operation, metal-air batteries are particularly suitable for the automotive sector and more generally for transport. This entailed a considerable research effort in solving the problems connected with their operation; from the 90s to today various patents have been filed, various prototypes have been built and some models have been produced on the market, even if mainly intended for use as emergency buffer batteries in the electronic or military sector.

Among the various metals that can be used for this class of batteries, the highest performing is certainly Lithium, which however requires a non-aqueous electrolyte due to explosive hyperactivity problems. Lithium allows energy densities of more than 20 times the density of lithium-ion batteries, which however are rechargeable.

The metals that have proved most suitable for practical applications are Zinc and Aluminum: they have theoretical energy densities equal to more than 5 times that of Lithium-ion batteries. Some models of Zinc-Air permeable membrane batteries are currently on the market. Most of the research has focused on these two metals, both due to the performance that can be obtained, and due to the availability and low cost of the raw material.

As previously described, the current batteries consist of a metal anode in contact with an electrolyte which in turn is in contact with the conducting cathode separated from the air by an air permeable membrane. The electrolyte can be an aqueous solution retained by an absorbent material or a conductive gel.

The anode can be metal in granular form, or in the form of plates or other suitable geometric shapes. The final voltage of the battery depends a lot on the electrolyte used and varies from 0.70 Volts for distilled water up to 1.70 Volts for Potassium Hydroxide KOH. This configuration is mainly dictated by the compactness and ease of construction and has shown that it can only partially solve the problems related to the electrochemical reactions underlying the technology. In fact the voltage, the power and the effective energy density expressed by the models developed are still far from the theoretical values obtainable.

However, known metal-air batteries have various disadvantages. In particular, the main problems are essentially due to the following factors:
1. the reactivity of the metal, in particular in the presence of the electrolyte;
2. the low conductivity of the electrolyte;
3. the low contribution of oxidant compared to the oxidative capacity of the anode; and
4. the reaction by-product that “clogs” and/or hinders the conductivity of the electrolyte.

As regards the first point, zinc and aluminium (and thus all the usable metals) continue to oxidise in the presence of the electrolyte even in an open circuit (no load). This means that metal-air batteries intrinsically tend to degrade very rapidly (passivation or passive oxidation) even if not used to produce electromotive force. This phenomenon is not insignificant and has resulted in important lines of research (and related patents) mainly towards techniques of “doping” the anode metal. For example, in the case of aluminium, additions of other chemical components have been tested in order to slow down the passive oxidation. The problem has not been solved and the models currently on the market based on Zinc and Aluminum are essentially intended for emergency batteries and not intended for continuous use for this very reason.

Regarding the second point mentioned above, the electrolyte is usually retained through absorbent materials that do not allow excellent permeability and diffusion of ions. In the case of gel, the mobility improves but the resistance and the electrical dispersion remain high, with a consequent increase in temperature. Important research has been carried out and interesting results have been achieved in the use of particular salts or chemical components to be added to the electrolyte. In some cases a part of the oxidant (OH− ions) has been added to the electrolyte itself; however, such techniques increase the weight of the battery.

Regarding the third point, most of the developed batteries “extract” oxygen from a permeable membrane. On this topic, the technology has developed many (patented) solutions based essentially on new classes of polymers. However, the natural percentage of oxygen present in the air (approximately 20%) and the intrinsic permeability of the membranes do not allow a flow of oxygen such as to reach the theoretical levels of energy density and power permitted by aluminium, zinc and other metals.

Regarding the fourth point, the basic reaction in an Aluminum-Air battery is the following:

4Al+6H₂O+3O₂→4(AlOH)₃,

wherein Al(OH)₃ represents the reaction by-product. The Al (OH)₃, commonly called Aluminum Hydroxide or Hydroclay, is a gelatinous compound which, although insoluble and heavier than water (density 2.40 kg/litre), tends to remain adherent to the walls of the metal anode or suspended in the electrolyte; this prevents the contact of the ions with the metal and prevents the continuity of reaction. The same effect occurs for the reaction by-product of the Zinc-Air batteries (Zinc Oxide ZiO) and of all the other usable metals. The best conformation of the anode is that in the form of a plate as it exposes the largest possible surface area to the ions for the reaction. By its nature, the reaction produces a porosity on the surface of the aluminium in correspondence with the groups of molecules that participate in the oxidation; the aluminium hydroxide tends to remain in the porosities, preventing the contact of the reactants (clogging).

A further similar problem arises in the phenomenon of “passivation” described above: in the case of an open circuit the inflow of hydroxyl ions OH− is certainly lower but still present due to the natural ionic dissociation of equilibrium of the aqueous electrolyte. This results in, in addition to the consumption of the anode, the clogging described.

Also in this case, the research focused on appropriate “doping” of both the anode and the electrolyte with the aim of making the by-product aggregate by crystallization or adhesion around particles that free the surface of the metal of the anode.

### SUMMARY

The disadvantages mentioned above, in particular those referred to in points 1, 3 and 4, constitute the main technical obstacles to the creation of an aluminium-air (and more generally metal-air) battery that is:
reliable for commercial use,
without charge degradation,
with energy density and power higher than the best rechargeable batteries based on lithium-ion or lithium-polymer technology,
can be regenerated by simply replacing the aluminium anode,
manageable and modular by means of suitable electronic controllers, and
intrinsically safe.

In the light of the above, the need to have metal-air batteries that overcome the disadvantages of prior art batteries appears evident.

This is the background to the solution according to the invention, which aims to provide a metal-air battery having characteristics capable of solving the above-mentioned problems, allowing a greater efficiency, reliability and duration of this type of battery. In particular, the proposed construction scheme for a metal-air battery according to the invention makes it possible to:
solve the problem of passivation and degradation of the battery when in open circuit;
obtain a continuous and sufficient oxidant flow to use in a massive manner the reaction potential of the anode almost to theoretical levels; and
solve the problem of the reaction by-products, ensuring their recovery and eliminating them from the contact surface of the anode as they are produced, without allowing them to remain in suspension in the electrolyte.

Furthermore, the battery according to the invention allows a standardization of configuration and a stability of use which would allow its commercial diffusion.

These and other results are obtained according to the invention, by proposing a metal-air battery comprising anode inertization means capable of preventing or slowing down the phenomenon of passivation of the anode. Said metal-air battery, in an optimal configuration, can also comprise an anode cleaning system to avoid the accumulation of the reaction by-product, and can be connected to an oxygen and nitrogen separator/concentrator from the atmospheric air which is capable of maximising the reaction potential of the anode.

The aim of the invention is to provide an efficient metal-air battery which allows the limitations of the prior art solutions to be overcome and to obtain the technical results described above.

The use of the battery according to the invention allows a drastic reduction of CO₂ emissions into the atmosphere; with the same mechanical power used, the burnt hydrocarbons emit 9 times more carbon dioxide into the atmosphere (in addition to NOx and other harmful components). More in detail, it is known that 1 kg of burnt diesel produces 3.16 kg of CO₂ and 12.2 thermal kWh equal to approximately 4.0 mechanical kWh. On the other hand, for the electrolytic transformation of 1 kg of Aluminum from 1.7 kg of Aluminum Oxide, approximately 0.5 kg of CO₂ is introduced and 13.0 kWh of electricity are needed, which can be produced from sustainable sources; moreover, one kg of aluminium produces about 6 kWh of electricity with the battery which is the subject of this patent application.

Furthermore, an electric propulsion system such as the one proposed according to the invention greatly reduces noise and vibrations, which is an important quality for both land and marine vehicles.

A further aim of the invention is that said device can be made with substantially low costs, with regard both to the production costs and the management costs.

Last but not least, the aim of the invention is to create a device that is substantially simple, safe and reliable.

It is therefore a specific object of the present invention an accumulator, in particular a rechargeable electrical energy accumulator comprising a metal-air electrochemical cell, or battery, and an oxygen and nitrogen separator/concentrator connected to said battery and configured for separating and concentrating separately the oxygen and nitrogen present in the air, wherein said battery comprises a container made of non-conductive material inside of which a reaction chamber is defined, said reaction chamber containing at least one metal anode, at least one cathode, connected to said oxygen and nitrogen separator/concentrator, and an electrolyte placed in contact with said at least one metal anode and at least one cathode, wherein said battery comprises
means for inertization of the anode by interposing an inert gas between said at least one anode and said electrolyte when the battery is not in use,
ultrasonic piezoelectric transducers configured for cleaning the anode, positioned near the edge of said container and/or on the surface of said at least one anode, so that they are immersed in said electrolyte, said piezoelectric ultrasonic transducers generating a continuous ultrasonic pressure wave, with frequency modulation configured for generating the detachment from said at least one anode of a by-product of the reaction of the anode by resonance, and with time and frequency phase shift of the waves of the individual piezoelectric transducers such that the sum of the wave crests creates a pressure front which translates, causing a displacement of said by-product towards the bottom of said container,
and wherein said oxygen and nitrogen separator/concentrator comprises an oxygen outlet and a nitrogen outlet, said oxygen outlet being hydraulically connected to said reaction chamber through an oxygen inlet nozzle placed in the proximity of said cathode.

According to the invention, said means of inertization of the anode are configured for avoiding the passivation of the anode when the battery is not in use, in particular by separating the anode from the electrolyte, or vice versa, and inertizing the anode by means of a flow of inert gas, said inert gas preferably being nitrogen, more preferably the nitrogen leaving said oxygen and nitrogen separator/concentrator.

According to a preferred embodiment, said oxygen and nitrogen separator/concentrator is chosen between an oxygen and nitrogen separator/concentrator with PSA (Pressure Swing Adsorption) technology and a membrane oxygen and nitrogen separator/concentrator, in particular with selective polymeric membranes.

According to the invention, the setting parameters of said piezoelectric ultrasonic transducers, such as for example the resonance frequency and the duration of the pulses, depend on various factors, such as for example the quantity of electrolyte, its temperature and the shape of the anode that wears out with use. An optional electronic control unit can be provided to take into account the return echoes and to find the best combination of pulse frequency and duration.

According to an embodiment of the invention, said battery can comprise an anti-passivation chamber defined by a closing container which is configured for hermetically closing said container, and said inertization means can be mechanically or hydraulically operated means configured for lifting said anode from said reaction chamber towards said anti-passivation chamber, in such a way as to totally separate said anode from said electrolyte. The anti-passivation chamber may be connected to an inert gas source and may comprise an inert gas inlet nozzle and an inert gas outlet nozzle.

In particular, according to a preferred embodiment, said nitrogen outlet of the oxygen separator/concentrator can be hydraulically connected to said anti-passivation chamber through said inert gas inlet nozzle.

According to a further embodiment of the invention, said battery can comprise a tank hydraulically connected to said reaction chamber, and said inertization means can be pressure means connected to a source of inert gas configured for introducing said inert gas under overpressure inside said reaction chamber so that the electrolyte is pushed towards said tank when said battery is not in use and said anode is immersed in said inert gas when the battery is not in use.

According to a preferred embodiment, said source of inert gas is said nitrogen outlet of said oxygen and nitrogen separator/concentrator.

According to the invention, said cathode is preferably a cathode with a three-dimensional lattice structure.

According to the invention, said container can be substantially rectangular in shape, said anode can be a substantially rectangular plate adjacent to a wall of said container and said cathode can also be substantially rectangular in shape and adjacent to the opposite wall of said container with respect to the anode.

Alternatively, according to the invention, said container can be substantially cylindrical in shape, said cathode can have a substantially hollow cylindrical shape and is adjacent to the inner wall of said container and said anode can be a solid cylinder placed concentrically with respect to said cathode.

According to the invention, said anode can be made of Aluminum, Lithium, Iron, Cadmium, Zinc, Calcium, preferably Aluminum.

### BRIEF DESCRIPTION OF THE DRAWINGS

The invention will now be described, by way of example and without limiting its scope, with reference to the accompanying drawings which illustrate a preferred embodiment of it, wherein:

FIG. 1 shows a side view of a system for accumulation and release of electricity according to the invention comprising a metal-air battery according to the invention;

FIG. 2 shows a block diagram of the system shown in FIG. 1;

FIG. 3 shows an exploded view of the battery shown in FIG. 1, and

FIG. 4 shows an exploded view of an alternative embodiment of a metal-air battery according to the invention.

### DETAILED DESCRIPTION OF THE EMBODIMENTS

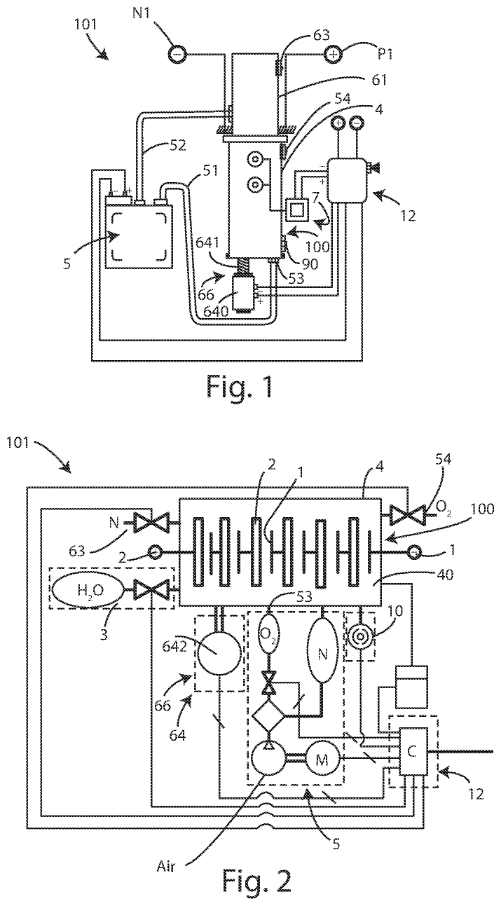

With reference to FIGS. 1-4, an accumulator 101 according to the invention, in particular a rechargeable electric energy accumulator 101, comprises a metal-air electrochemical cell 100, or metal-air battery 100 or battery 100, comprising a container 4 made of non-conductive material, which internally defines a reaction chamber 40, an anode 1, a cathode 2 and an electrolyte 3, in particular a liquid electrolyte 3, located inside said reaction chamber 40. Said anode 1 and said cathode 2 are separated from each other and in contact with said electrolyte 3 inside said reaction chamber 40. Said anode 1 and cathode 2 are connected respectively to a negative power electrode N1 and to a positive power electrode P1, located outside said reaction chamber 40. An oxidation-reduction reaction takes place inside the reaction chamber 40 in which the anode 1 oxidizes and the cathode 2 is reduced with consequent passage of electric current.

Furthermore, the metal-air battery 100 comprises by means of inertization 66 of the anode configured for inertizing the anode 1 by interposing a flow of inert gas between said anode 1 and said electrolyte 3, separating said anode 1 from said electrolyte 3 in order to protect the anode 1 from the passivation phenomenon when the battery is not used. Said metal-air battery 100 also comprises an anode cleaning system consisting of piezoelectric ultrasonic transducers 10 connected to the reaction chamber 40, for cleaning the anode of the reaction by-products.

Furthermore, said accumulator 101 comprises an oxygen and nitrogen separator/concentrator 5 connected to said metal-air battery 100, connected to said reaction chamber 40 at the cathode 2, to introduce oxygen at concentrations higher than those of the oxygen present naturally in the air. Said oxygen and nitrogen concentrator/separator 5 is therefore capable of maximising the reaction potential of the anode.

Finally, said accumulator 101 can comprise a control unit 12, configured to control said anode inertization means 66, ultrasonic piezoelectric transducers 10, oxygen and nitrogen separator/concentrator 5, as described in more detail below. For example, said control unit 12 can be an external controller 12 of the HW and SW type.

The inertization means 66, the ultrasonic piezoelectric transducers 10 and the oxygen and nitrogen separator/concentrator 5 perform a synergistic action inside the accumulator 101, although they are also useful individually. Such systems act in different moments and phases of the use of the metal-air battery 100 and allow its operation. In particular, the inertization means 66 of the anode act when the metal-air battery 100 is at rest. The oxygen and nitrogen separator/concentrator 5 is useful for achieving and maintaining the power performance of the metal-air battery 100. The ultrasonic piezoelectric transducers 10 are useful when the anode 1 becomes clogged due to the reaction by-products of the metal-air battery 100.

All the elements of the accumulator 101 mentioned above (anode inertization means 66, control unit 12, piezoelectric ultrasonic transducers 10, oxygen and nitrogen separator/concentrator 5) are powered by the metal-air battery 100 itself when this is in operation, drawing part of the generated power. In particular, the oxygen and nitrogen separator/concentrator 5, when the metal-air battery 100 is in the switching on phase, should have a certain amount of oxygen available in the tank sufficient to start the reactions.

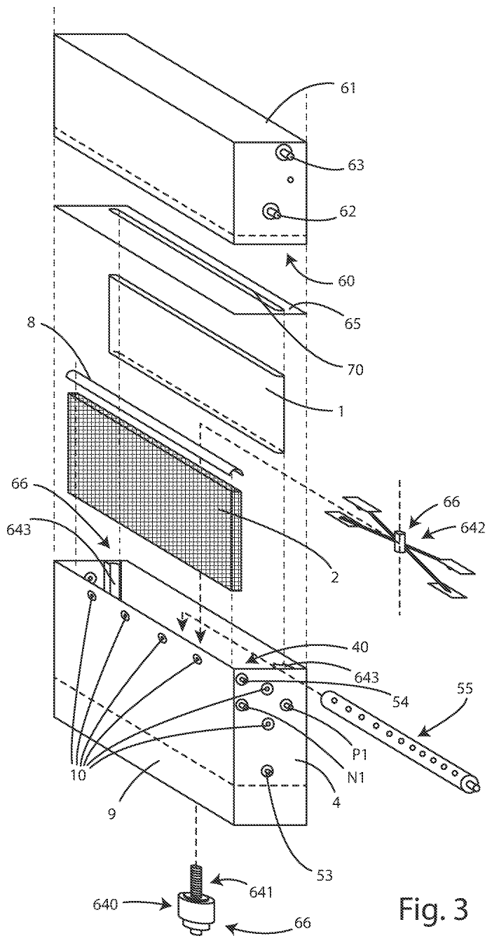

As shown in FIG. 3, the anode 1, preferably an aluminium anode, can be a flat rectangular plate (hereinafter also referred to as anode plate 1), with a thickness suitable for the energy reserve that the battery must ensure, placed vertically inside said reaction chamber 40, with the longest axis placed horizontally inside said container 4, with a parallelepiped shape having a face of similar dimensions to that of the anode plate 1. Again with reference to FIG. 3, the anode 1 is positioned on one of the internal vertical faces of the container 4 and is free to move vertically. The container 4 is impermeable and contains the electrolyte 3, preferably an aqueous electrolyte in liquid form, and, on the face opposite the anode 1, it houses the cathode 2. Preferably, the distance between the cathode 2 and the anode 1 is approximately 3-4 times the thickness of the anode plate 1. Again with reference to FIG. 3, the cathode 2 is a reticular cathode, that is, a cathode with a three-dimensional lattice structure consisting of a dense conductive lattice and it has a substantially rectangular shape with dimensions similar to that of the anode plate 1. The oxygen must be in contact with the cathode 2 and the electrolyte to generate the hydroxyl ions (OH)⁻ which feeds the metal of the anode 1. The solution according to the invention is a dense three-dimensional lattice cathode (that is, a “reticular mesh”, the appearance of which is similar to a fishing net) in which the micro bubbles of oxygen are captured by surface tension. The material of the cathode 2 is an inert non-metallic conductor, in order to avoid oxidation, for example made of a material belonging to the family of graphites or “complex carbons”.

According to the embodiment shown in FIGS. 1-2, the container 4 is externally connected to the oxygen and nitrogen separator/concentrator 5, which concentrates the oxygen present in the air by separating it from the nitrogen. Said oxygen and nitrogen separator/concentrator 5 comprises an air inlet (not shown), an oxygen outlet 51 and a nitrogen outlet 52, said oxygen outlet 51 being hydraulically connected to said reaction chamber 40 through a oxygen inlet nozzle 53 placed on said container 4 in the proximity of the cathode 2. In particular, it is preferable for said oxygen inlet nozzle 53 to be placed on the bottom of said container 4, so that the oxygen introduced comes into contact with the cathode 2 bubbling upwards through the liquid electrolyte 3. Said oxygen and nitrogen separator/concentrator 5 can be based on a PSA (Pressure Swing Adsorption) system, in particular with a Zeolite molecular sieve, or on separating membrane filters or molecular filters, using a pressure storage tank in which oxygen is stored, which will be available when the battery is switched on. These systems (commercially available) separate the atmospheric air into Nitrogen and Oxygen. The current technology allows nitrogen to be obtained with a purity of 99.9% and oxygen with a purity of between 95% and 98%. Said oxygen and nitrogen separator/concentrator 5 can be controlled by a control unit 12, in particular an external control unit, for automatic flow regulation. In particular, said control unit 12 is configured to receive signals from sensors connected to it so as to regulate the flow on the basis of the electrical and power parameters supplied. Said control unit 12 can also be configured to control said inertization means 66 of the anode and said ultrasonic piezoelectric transducers 10, as better illustrated below.

In the particular embodiment shown in FIG. 3, a bubbling device 55 provided with bubbling nozzles 550 is located inside said reaction chamber 40, connected to said oxygen inlet nozzle 53 and placed below the reticular cathode 2, in so that the oxygen gas (02) flows upwards in the form of micro-bubbles through the conductive lattice constituting the cathode 2. Again according to the embodiment shown in FIG. 3, above the reticular cathode 2 there is a cathode bell 8, that is, a concave surface overhanging the cathode 2, said bell 8 being configured for collecting the excess oxygen bubbled through the reticular cathode 2 and being placed in proximity to an oxygen outlet nozzle 54 located in the upper portion of said container 4 in proximity to cathode 2. The oxygen captured by said bell 8 of the cathode can be reintroduced into the circuit or it can be expelled outside if in excess.

As mentioned above, the metal-air battery 100 comprises inertization means 66 of the anode, which counteract the phenomenon of the passivation of the anode.

With particular reference to the embodiment shown in FIG. 1, said battery 100 comprises an anti-passivation chamber 60 adjacent to said reaction chamber 40 and adapted to house the anode 1. In particular, said anti-passivation chamber 60 can be defined by a closing container 61 located above said reaction chamber 40, in which said closing container 61 acts as a hermetic lid or cap able to hermetically close said container 4.

With particular reference to FIG. 3, said inertization means 66 are lifting means 64, connected to the anode plate 1 and configured for lifting said anode plate 1 entirely beyond the free surface of the liquid electrolyte 3 and to house it inside said anti-passivation chamber 60. With particular reference to FIG. 3, said lifting means 64 can comprise a lifting motor 640 connected to a screw 641, in turn connected to a lifting device 642 capable of lifting the anode plate 1 under the actuation of said lifting motor 640. Said lifting can take place along the lifting guides 643 placed on the internal side walls of said container 4, along which the anode plate 1 can slide to be raised up to said anti-passivation chamber 60.

Said lifting means 64 of the anode plate 1 can be modulated according to the power required from the battery. The lifting means 64 can be of the direct mechanical type and, in this case, they can comprise electric motors with a screw or rack, or they can be of the pressure type (hydraulic or pneumatic) or they can be of the hydrostatic type. In any case, said lifting means 64 are preferably connected to said external control unit 12 (HW and SW), capable of modulating the lifting according to the needs and signals received from suitable sensors (current absorption, temperature, voltage, etc.). When the metal-air battery 100 is switched on and off, the lifting means 64, the control unit 12 and possibly also the piezoelectric ultrasonic transducers 10 can be powered by a “buffer battery”, in particular of the rechargeable type, which can be connected to the metal-air battery 100 when charging.

With reference to FIGS. 1 and 3, said closing container 61 comprises an inert gas inlet nozzle 62, in this case hydraulically connected to said nitrogen outlet 52 of the oxygen and nitrogen separator/concentrator 5, configured for introducing nitrogen inside the anti-passivation chamber 6, and an inert gas outlet nozzle 63, configured for making the inert gas, in this case nitrogen, come out from the anti-passivation chamber 6. According to other embodiments, said anti-passivation chamber 60 can be fed with an inert gas other than nitrogen, such as argon for example. The inert gas prevents surface oxidation of the anode plate 1 by the atmospheric air when the plate is housed in the anti-passivation chamber 60. Just as the hydroxyl ions of the water produce a degradation of the metal of the anode 1, obscuring the surface “reaction layer”, similarly the oxygen present in the air creates a layer of aluminium oxide on the surface of the reaction layer. These deposits of aluminium oxide or aluminium hydroxide prevent the contact of the hydroxyl ions with the metal, inhibiting the reaction. An inert gas protects the surface of the anode 1 from atmospheric oxygen and keeps the reaction layer clean.

For this reason, according to the above-mentioned embodiment, said oxygen and nitrogen separator/concentrator 5 produces Nitrogen and Oxygen gas in two separate circuits, wherein the Nitrogen is destined for the anti-passivation chamber 6, while the Oxygen is destined for the bubbling device 55 present inside the reaction chamber 40 to be diffused in the form of micro-bubbles through the reticular cathode 2, which suitably feeds the electrolyte solution 3 with hydroxyl ions and receives the electrons generated at the anode 1.

Said battery 100, in addition to said anti-passivation chamber 60 can also comprise an anti-lapping partition 65, that is, a separation partition between said anti-passivation chamber 60 and said reaction chamber 40, to prevent the electrolyte 3 from entering in the anti-passivation chamber when said electrolyte is subjected to sudden accelerations, for example due to the movement of the vehicle. In particular, as shown in FIG. 3, said anti-lapping partition 65 can be an elastic polymer membrane placed transversely between said anti-passivation chamber 60 and said reaction chamber 40 and comprising a slot 70 configured for passing the anode plate 1 when raised from the reaction chamber 40 towards the anti-passivation chamber 60 and vice versa.

For this reason, according to the embodiment shown in FIGS. 1-3, said anode 1, when the metal-air battery 100 is not in use, is raised by said lifting means 64 inside said anti-passivation chamber 60 to be treated with the nitrogen coming from said oxygen and nitrogen concentrator/separator 5. The excess nitrogen in the anti-passivation chamber is expelled to the outside by means of said inert gas outlet nozzle 63, which may comprise suitable outlet valves.

According to an alternative embodiment, in particular in the case of large batteries which result in a high weight of the plate (for example batteries for naval use for boats, yachts and even large ships), said battery 100, as an alternative to the anti-passivation chamber 60, can comprise a tank for emptying the electrolyte 3 from the container 4 and said inertization means 66 of the anode can consist of pressure means connected to a source of inert gas, such as nitrogen, configured for applying an overpressure of the an inert gas. In particular, in this case the anode plate 1 can be fixed to a hermetic lid which is able to hermetically close said container 4, in which said hermetic lid houses one or more nozzles for the introduction of inert gas, such as nitrogen, in overpressure, for example in overpressure of about 1.8 atmospheres. Therefore, according to this embodiment, when the battery is at rest or at reduced power, inert gas is introduced under overpressure to push the electrolyte 3 into the adjacent tank through a valve. In order to reactivate the battery, the vent valve of the electrolyte collection tank 3 is opened and the overpressure inert gas is introduced into the tank, which pushes the electrolyte liquid back into the container 4 from said tank. Said tank can be adjacent to the container 4 containing the electrolyte 3, or it can be a centralised tank connected to said container 4 by a suitable circuit.

Furthermore, as mentioned above, the metal-air battery 100 according to the invention comprises the piezoelectric ultrasonic transducers 10, configured for cleaning the anode of the reaction by-product (for example, in the case of an aluminium-air battery, aluminium hydroxide is generated) which is generated in suspension on the surface of the anode.

According to the particular embodiment shown in FIGS. 1-3, the ultrasonic piezoelectric transducers 10 are positioned on the upper part of the walls of the container 4 near the edge but immersed in the aqueous solution of the electrolyte 3. However, said ultrasonic piezoelectric transducers can also be positioned on the anode plate 1.

Said ultrasonic piezoelectric transducers 10 are connected to an external ultrasonic wave generation system 11. Said ultrasonic wave generation system 11 can be based, for example, on the commercial technology of ultrasonic washing machines.

Said ultrasonic piezoelectric transducers 10 have the function of emitting calibrated waves for cleaning the anode 1 and generating a displacement wave of the by-product, for example of the aluminium hydroxide, towards the bottom of the container. In particular, said ultrasonic piezoelectric transducers 10 generate a continuous ultrasonic pressure wave, with frequency modulation, configured for generating the detachment from said anode 1 of the by-product of the reaction of the anode 1 by resonance, and with time and frequency phase shift of the waves generated by the individual piezoelectric transducers 10 such that the sum of the wave crests creates a pressure front which translates, causing a displacement of said by-product towards the bottom of said container 4. On the bottom of the container 4 there is preferably a compartment 9 for depositing the by-product. Said compartment 9 for depositing the by-product can comprise, as shown in FIG. 1, a hole 90 for collecting the by-product. One or more transducers 10 can also be placed directly on the anode plate 1.

As mentioned above, the ultrasonic piezoelectric transducers 10 are powered by taking part of the power generated by the battery itself. However, said transducers 10 can be powered with a buffer battery when the metal-air battery 100 is off. By way of example, the ultrasonic piezoelectric transducers 10 powered with a buffer battery can be used for pre-cleaning the anode 1 or for directing any by-products of reaction in suspension towards the collection chamber.

The operation of said ultrasonic piezoelectric transducers 10 can be regulated by said external control unit 12. In particular, when said transducers 10 are connected to said external control unit 12, the latter is able to modulate the frequency and intensity of the waves on the basis of the electromotive force extracted from the battery. In the event of a decrease in the power delivered by the metal-air battery 100, with the same volume of oxygen supplied, the control unit 12 will receive this information from special sensors in such a way as to recognise the clogging of the anode and command the cleaning cycle by means of said transducers 10.

As shown in FIGS. 1-3, the metal-air battery 100 according to the invention preferably has a flat and vertical shape and can be removed from the device it powers, in which the oxygen and nitrogen separator/concentrator 5, the lifting means 64 and the external controller 12 are preferably present in a stable form.

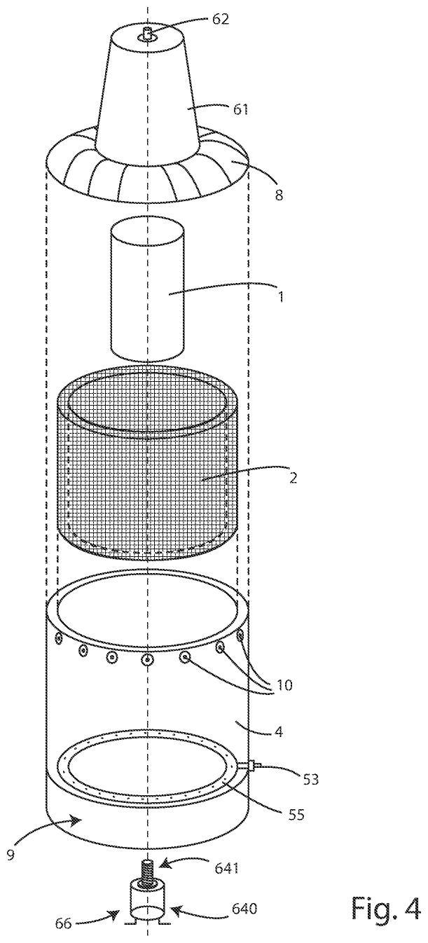

With particular reference to FIG. 4, the metal-air battery 100 according to the invention can adopt an alternative configuration, in which the container 4 of said metal-air battery 100 has a substantially cylindrical hollow shape and the cathode 2 and the anode 1 they are concentric. In particular, according to the embodiment shown in FIG. 4, the anode 1 is a solid cylindrical bar with a circular base and is located inside the reticular cathode 2, which in turn has a hollow cylindrical shape and is adjacent to the internal cylindrical hollow wall of the container 4. According to this embodiment, the anti-passivation chamber 60 is defined by a closing container 61 arranged in the upper portion of said container 4, which has a substantially cylindrical or truncated cone shape. In proximity to the portion of said closing container 61 which comes into contact with said container 4, said closing container 61 comprises said bell 8 of the cathode, having a concave shape which overhangs the reticular cathode 2 adjacent to the hollow cylindrical wall of container 4. Moreover, said closing container 61 can hermetically close said container 4.

Therefore, a metal-air battery 100 according to the invention comprises inertization means 66 of the anode configured for inertization of the anode 1 by separating it from the electrolyte 3 when the battery is not in use and, in particular, it can comprise an anti-passivation chamber 60 in which to house the anode by moving it from the reaction chamber 40 in which the electrolyte 3 is present by means of lifting means 64 or it can comprise a tank for emptying the electrolyte 3 from the reaction chamber 40 by means of pressure means. Said metal-air battery 100 further comprises also said piezoelectric ultrasonic transducers 10 configured for cleaning the anode, which remove the reaction by-product and favour its displacement towards the bottom of said container 4, in which there is preferably a compartment 9 for collecting the by-product. In addition, said battery-metal air is connected to an oxygen and nitrogen separator/concentrator 5, in order to supply the cathode 2 with more concentrated oxygen than the quantity of oxygen naturally present in the air.

The metal-air battery 100 according to the invention can be advantageously regenerated when exhausted. In fact, when the battery runs out, the entire container 4 can be removed from the vehicle and replaced. The new container 4 is connected to the electric power circuits, to the gas circuits and to the control circuits of the piezoelectric transducers 10. The container 4 removed can then be destined for regeneration, where said closing container 61 (which defines the anti-passivation chamber 60) is opened and emptied of the aqueous solution of electrolyte 3 and of the by-product, such as for example aluminium hydroxide. The container 4 and the reticular cathode 2 can be washed and a new anode plate 1 can be placed in the anti-passivation chamber 60, filled with aqueous electrolytic solution, the closing container 61 sealed and filled with nitrogen.

The collected by-product can be sent to a regeneration process. In the case of aluminium hydroxide, this can be regenerated into metallic aluminium (aluminium hydroxide is the final product in the Bayer process for the production of aluminium oxide or alumina Al₂O₃, from which metallic aluminium is obtained by electrolysis with the Hall-Héroult process). In this way the battery is regenerated waiting to be installed on the device to be powered.

The electrochemical reactions which take place in the reaction chamber 40 are shown below in an example of an aluminium-air battery:

Anode: Al+3OH⁻→Al(OH)₃+3e⁻−2.31 Volts

Cathode: O₂+2H₂O+4e⁻→4(OH)⁻+0.40 Volts

In balance:

4Al+6H₂O+3O₂→4Al(OH)₃+2.71 Volts(theoretical)

With the configuration illustrated above, the battery according to the invention becomes more similar to a flow cell, where the oxygen is in any case captured by the atmospheric air. The final average voltage is about 2.00 Volts, but it can vary according to the applied load and the quality of the electrolyte.

The invention is now described, by way of example and without limiting the scope of the invention, with reference to some examples.

### Example 1. Example of Sizing of the Device According to the Invention

For a metal-air battery of the aluminium-air type, in which the specific reactions are as follows
Anode: Al+3OH−→Al(OH)₃+3 e⁻
Cathode: O₂+2H₂O+4 e⁻→4(OH)⁻
In balance: 4Al+6H₂O+3O₂→4Al(OH)₃,
the calculation of the specific operating characteristics necessary for the sizing of the battery configuration proposed by the invention is shown below.
Basic data:
Avogadro constant: 6.022*10²³
Molar mass Aluminum: 27 Grams
Molar mass molecular Oxygen: 16 Grams
Molar volume Oxygen: 17.36*10⁻³ [m³/mole]
Molar mass OH−: 17 Grams
Molar mass H₂O: 18 Grams
Elementary charge: 1.602*10⁻¹⁹ Coulombs [Amperes*sec]
Covalent radius Aluminum: 1.25*10⁻¹² [M]
The quantity of reactants involved is obtained from the reaction equations:

Aluminium: 4 moles×27 Grams=108 Grams

Oxygen: 3 moles×16 Grams=48 Grams equal to 52 Litres(in standard conditions)

Water: 6 moles×18 Grams=108 Grams equal to approximately 0.108 Litres

[e⁻]: 12 moles×6.022*10²³ electrons equal to 115.77*10⁴ Coulombs

Therefore, in stoichiometric conditions 108 grams of Aluminum have a charge density equal to 115.77*10⁴ Coulombs/3600=321.6 Ah [Amperes*h] (consuming 52 Litres of Oxygen equal to approximately 250 Litres of atmospheric air).

The charge density per unit of metal weight is equal to:

321.6/0.108[Amperes*h/kg]=2,978 Ah/kg_{Al}

Applying the average voltage of 2.00 Volts, the (design) Energy Density of the battery is equal to:

W=A*V=2,978*2.00[Amps*h*Volts/kg]=5,956 Wh/kg_{Al}

The calculation of the deliverable design power depends on the reaction rate which in turn depends on the anode surface exposed to the reaction and on the volume of oxygen per second supplied.

The “average statistical distance” is the distance between two aluminium molecules equal to twice the Covalent Radius, equal to 2*1.25*10⁻¹² [M]=2.50*10⁻¹² [M], the number of atoms of aluminium per cm² present on the surface of a flat plate (called “reaction layer” or Reaction Foil) is equal to:
on a side of 1 cm: 10⁻²/2.50*10⁻¹² [M]/[M] molecules=4.0*10⁹ molecules/cm;
in a cm²: 4.0*4.0*109=1.6*10¹⁹ molecules/cm²

By applying a “porosity/roughness” coefficient equal to 2, the number of moles of metal reacting per unit of flat anode surface is obtained:

Aluminum Reaction Layer: 5.32*10⁻⁵ [moles]/cm²

1 cm² of anode plate therefore releases in a second (see reactions):

Free electrons (electrical charges): 3×5.32*10⁻⁵=1.6*10⁻⁴ [moles]/cm²_{Al} equal to 15.43 Amperes*sec/cm²_{Al}

and consumes ¾ *5.32*10⁻⁵ [moles]/cm²_{Al} sec of Oxygen 02=3.99*10⁻⁵ [moles]/cm²_{Al} sec, that is, 6.93*10⁻⁴ [litres/sec*1/cm²] of oxygen gas.

So with a flow rate of 6.93*10-4 litres/sec of Oxygen, 1 cm² of aluminium plate exposed to the anode theoretically generates 15.43 Amps.

However, similarly to what happens on the surface of the anode, the effectiveness of molecular oxygen depends on its ability to interact with the cathode to dissociate OH-hydroxyl ions; in particular it depends on:
the contact surface of the gas bubble with the conducting cathode,
the percentage of oxygen solution in the water,
and therefore on the dimensions of the micro-bubble, its internal pressure, the surface area of the cathode etc.

Under standard conditions an OH⁻ production engineering coefficient of 35% can be applied. For this reason, the available current will be:

Current per cm²: 0.35*15.43 Amperes/cm²=5.4 Amperes/cm²_{Al}

Design power per cm²: 2.00 Volts*5.4 Amperes/cm²=10.8 W/cm²_{Al} (with a flow of 6.93*10-4 litres/sec/cm²_{Al} of Oxygen).

An appropriate geometric shaping of the surface of the sheet can contribute, for the same projected surface, to a considerable increase in the power of the battery by increasing the surface exposed to the reaction. For example, the creation of pyramidal protuberances with a side of 1 cm and an apothem of 0.5 cm, produces a doubling of the surface area exposed to the reaction for the same projected surface area.

Another solution that increases power is the use of small aluminium spheres to be loaded into a conductive “basket” immersed in the electrolyte instead of a plate. In this case, the “filling” of the battery is facilitated and the available power is increased, but the energy charge is reduced for the same volume occupied.

### Example 2. Example of Basic Configuration of an Aluminium-Air Battery According to the Invention Suitable for Heavy Vehicles

The basic battery configuration is as follows:

Anode: aluminium plate with dimensions 20 cm×40 cm×1.25 cm (Volume 1 litre; mass 2.7 kg)

Cathode: conductive mesh with dimensions 15 cm×25 cm×2.00 cm

Container: internal measurements: 25 cm×41 cm×7.00 cm, external measurements: depends on the plastic construction material, approximately 0.5 cm thick.

Electrolyte solution volume: approx. 6.00 litres.

Cathode-Anode Distance: 3.75 cm

Anti-passivation chamber: internal measurements: 20.5 cm×41 cm×7.00 cm, external measurements: 0.5 cm thick (plastic).

Anode surface: 800 cm² (without surface shaping)

Design Energy Capacity: 16.08 kWh

Maximum design power: 8.64 kW

Max Oxygen Flow: 0.554 litres/sec 33.3 litres/min

The battery is supported by an Oxygen Concentrator system which supplies the container: it can be associated with the device to be powered or individually associated with the battery.

Oxygen concentrator systems with various technologies from 5 to 250 litres/min of oxygen/nitrogen are available on the market from various manufacturers; the best technology is PSA for adsorption of nitrogen in zeolite, which require a compression of only two atmospheres. A 10 litre/min plant weighs about 8 kg and absorbs an average of 0.20 kW of power every 5 litres/min of oxygen flow produced.

The piezoelectric transducers necessary for cleaning the reaction product work in a range between 40 kHz and 60 kHz with an absorbed power of 60 W.

The power absorbed by the oxygen concentration system depends on the power regime requested from the battery and therefore the indicated value must be considered that at maximum operating speed.

A HW and SW system takes care of optimising the gas flows, the immersion of the plate in the electrolyte and the power of the transducers based on the power required from the battery.

This configuration is particularly suitable for trucks and heavy vehicles with powers of above 150 kW. The module must be associated in groups (10, 15 or 20) connected in parallel.

### Example 3. Example of Basic Configuration of an Aluminium-Air Battery According to the Invention Suitable for Cars and Motorcycles

A further standard configuration more suitable for cars and motorcycles is the following:

Anode: aluminium plate: 10 cm×40 cm×1.00 cm (Volume 0.4 litres; mass 1.08 kg)

Cathode: conductive mesh with dimensions 10 cm×25 cm×2.00 cm

Container: internal measurements: 13 cm×41 cm×4.50 cm, external measurements: depends on the plastic construction material, approximately 0.5 cm thick.

Electrolyte solution volume: approx. 2.00 litres.

Cathode-Anode Distance: 1.50 cm

Anti-passivation chamber: internal measurements: 10.5 cm×41 cm×4.50 cm, external measurements: 0.5 cm thick (plastic)

Anode projected surface: 400 cm²

Reaction surface Anode: 800 cm² (pyramid shaped surface)

Design Energy Capacity: 6.43 kWh

Maximum design power: 8.64 kW

Max Oxygen Flow: 0.532 litres/sec 33.3 litres/min

The module has overall external dimensions of 24.5 cm×42 cm×5.0 cm with an estimated weight of approximately 3.5 kg.

### Example 4. Example of Basic Configuration of an Aluminium-Air Battery According to the Invention Suitable for Naval Vessels

A sizing hypothesis for naval vessels such as boats, yachts and large ships is the following:

Anode: aluminium plate: 100 cm×200 cm×25 cm (Volume 50 litres; mass 135 kg)

Cathode: conductive mesh with dimensions of 100 cm×200 cm×30 cm Container:

internal measurements: 140 cm×205 cm×70 cm

internal tank measurements: 140 cm×205 cm×45 cm

external measurements: depends on the plastic construction material, approximately 2.0 cm thick.

Electrolyte solution volume: approx. 130 litres.

Cathode-Anode Distance: 15 cm

Anode projected surface: 20,000 cm²

Reaction surface Anode: 40,000 cm² (pyramid shaped surface)

Design Energy Capacity: 804.06 kWh

Maximum design power: 432.00 kW

For a medium-sized vessel with 864 kW (1,160 HP) of maximum installed power, 40 modules guarantee 75 hours (over 3 days) at full power. 40 modules occupy approximately 14,000 litres, equal to the volume dedicated to traditional tanks.

### Example 5. Comparison Between a Basic Configuration of an Aluminium-Air Battery According to the Invention Suitable for Passenger Cars and Conventional Hydrocarbon Fueling

The 1 kg aluminium automobile module has a thickness of 5 cm and is approximately 25 cm high and 42 cm long for a total weight of 3.5 kg. In groups of 15 the battery occupies 75 cm×42 cm×25 cm for a volume of 78.75 litres and a weight of 52.5 kg comparable with a conventional automobile tank (for example 40 kg of diesel fuel assuming a weight of 12.5 kg for the tank).

The battery is capable of delivering a maximum of 129.6 kWh of electricity (174 HP) and contains 96.45 kWh of energy. Since the electric energy is immediately usable in traction while the fuel has a conversion efficiency of about 22%, the comparable tank would have:

Diesel capacity: 40/0.800 [kg/kg/litre]=50.00 litres

Energy reserve: 12,200*40*0.22 [kWh/kg*kg]=107.4 kWh compatible with the 96.45 kWh of the battery.

The current cost to the public in Italy of fuel is € 1.4*50 litres=€70

The break even cost of the aluminium would be 70€/15/1.08 kg=4.32 €/kg_{Al} which is much higher than the current cost of aluminium (1.7 €/kg).

(Note: the initial installation costs are attributed to the car. Only the costs of regenerating the anode in the battery are considered: refuelling cost).

The present invention has been described by an illustrative, but not limitative way, according to its preferred embodiments, but it shall be understood that the invention may be modified and/or adapted by a person skilled in the art without thereby departing from the scope of protection, as defined in the appended claims.

1-10. (canceled)

11. A rechargeable electric energy accumulator comprising a metal-air electrochemical cell, or battery, and an oxygen and nitrogen separator/concentrator connected to said battery and configured for separating and concentrating separately the oxygen and nitrogen present in the air, wherein said battery comprises a container made of non-conductive material inside of which a reaction chamber is defined, said reaction chamber containing at least one metal anode, at least one cathode, connected to said oxygen and nitrogen separator/concentrator, and an electrolyte placed in contact with said at least one metal anode and at least one cathode, wherein said battery comprises:
means for inertization of the anode by interposing an inert gas between said at least one anode and said electrolyte when the battery is not in use,
one or more ultrasonic piezoelectric transducers configured for cleaning the anode, positioned near the edge of said container and/or on the surface of said at least one anode, so that they are immersed in said electrolyte, said piezoelectric ultrasonic transducers generating a continuous ultrasonic pressure wave, with frequency modulation configured for generating the detachment from said at least one anode of a by-product of the reaction of the anode by resonance, and with time and frequency phase shift of the waves of the individual piezoelectric transducers such that the sum of the wave crests creates a pressure front which translates, causing a displacement of said by-product towards the bottom of said container,
and wherein said oxygen and nitrogen separator/concentrator (5) comprises an oxygen outlet and a nitrogen outlet, said oxygen outlet being hydraulically connected to said reaction chamber through an oxygen inlet nozzle placed in proximity of said cathode.

12. An accumulator according to claim 11, wherein said oxygen and nitrogen separator/concentrator is selected between a PSA technology oxygen and nitrogen separator/concentrator and a membrane oxygen and nitrogen separator/concentrator.

13. An accumulator according to claim 11, wherein said battery comprises an anti-passivation chamber defined by a closing container configured for hermetically closing said container, and said inertization means are lifting means with mechanical or hydraulic actuation configured for lifting said anode from said reaction chamber towards said anti-passivation chamber, said anti-passivation chamber being connected to a source of inert gas and comprising an inert gas inlet nozzle and an inert gas outlet nozzle.

14. An accumulator according to claim 13, wherein said nitrogen outlet of said oxygen and nitrogen separator/concentrator is hydraulically connected to said anti-passivation chamber through said inert gas inlet nozzle.

15. An accumulator according to claim 11, wherein said battery comprises a tank hydraulically connected to said reaction chamber, and said inertization means are pressure means connected to a source of inert gas configured for introducing said inert gas under overpressure inside said reaction chamber so that the electrolyte is pushed towards said tank when said battery is not in use and said anode is immersed in said inert gas when the battery is not in use.

16. An accumulator according to claim 15, wherein said source of inert gas is said nitrogen outlet of said oxygen and nitrogen separator/concentrator.

17. An accumulator according to claim 11, wherein said cathode is a cathode with a three-dimensional lattice structure.

18. An accumulator according to claim 11, wherein said container is substantially rectangular in shape, said anode is a substantially rectangular plate adjacent to a wall of said container and said cathode is also substantially rectangular in shape and is adjacent to the opposite wall of said container with respect to the anode.

19. An accumulator according to claim 11, wherein said container is substantially cylindrical in shape, said cathode has a substantially hollow cylindrical shape and is adjacent to the inner wall of said container and said anode is a solid cylinder placed concentrically with respect to said cathode.

20. An accumulator according to claim 11, wherein said anode is made of aluminium, lithium, iron, cadmium, zinc, or calcium.
